(19) United States
(12) Patent Application Publication
(10) Pub. No.: US 2013/0173643 A1
(43) Pub. Date: Jul. 4, 2013

(54) PROVIDING INFORMATION MANAGEMENT

(71) Applicant: Ahmed K. Ezzat, Cupertino, CA (US)

(72) Inventor: Ahmed K. Ezzat, Cupertino, CA (US)

(21) Appl. No.: 13/821,213

(22) PCT Filed: Oct. 25, 2010
(86) PCT No.: PCT/US10/53925

§ 371 Date: Mar. 6, 2013

(51) Int. Cl. G06F 17/30

(52) U.S. Cl. CPC G06F 17/30557
USPC 707/756

(57) ABSTRACT

The present disclosure provides a computer-implemented method of handling data quality in a real-time information management environment. The method includes acquiring a first data set from an unstructured data source using a probabilistic Natural Language Processing (pNLP) engine, the first data set comprising a first tuple that describes a relationship and a corresponding probability that the relationship is accurate. The method also includes acquiring a second data set from a structured data source, the second data set comprising a second tuple that describes second relationship and probability reflecting that the second relationship is accurate. The method also includes storing the first and second data sets into a common data store using a common data format that includes the probabilities corresponding to the first data set and second data set.

### BACKGROUND

Enterprises use business intelligence (BI) technologies for strategic and tactical decision making. In many cases the decision-making cycle may span a time period of several weeks, such as in campaign management, or months, such as in improving customer satisfaction. However, competitive pressures are forcing companies to react faster to rapidly changing business conditions and customer requirements. As a result, there is an increasing desire to use business intelligence to help drive and optimize business operations on a daily basis and in some cases in near real-time. This type of business intelligence is called operational business intelligence.

In traditional business intelligence architectures, an extract-transform-load application is used to collected enterprise transactional data from a variety of data sources, including structured and unstructured data sources. The collected data is processed, for example, semantics are extracted from the unstructured data, and the data loaded into a data warehouse as structured data. The users can then run queries on the data warehouse, generate reports from the data warehouse, and the like.

The process of integrating the structured and unstructured data into a common data repository can mask inherent differences in data quality between structured and unstructured data. Quering such data will produce results with a quality as good as the lowest common denominator, thus polluting the high data quality typically associated with structured data. Furthermore, the process of extracting semantic meaning from unstructured data sources may be incomplete and that may distort the join operation between the structured and unstructured data resulting in an inaccurate result.

### BRIEF DESCRIPTION OF THE DRAWINGS

Certain exemplary embodiments are described in the following detailed description and in reference to the drawings, in which:

FIG. 1 is a block diagram of a system configured to integrate data from data sources of varying data quality, in accordance with embodiments of the invention;

FIG. 2 is a more detailed block diagram of FIG. 1 to provide real-time business intelligence while handling differences in data quality between the different data sources, in accordance with embodiments of the invention;

FIG. 3 is a process flow diagram of a method of integrating data from multiple data sources of different data quality, in accordance with embodiments of the invention; and

FIG. 4 is a block diagram showing a non-transitory, computer-readable medium that stores code for integrating data from data sources of varying data quality, in accordance with embodiments of the invention.

### DETAILED DESCRIPTION OF SPECIFIC EMBODIMENTS

Embodiments of the invention provide for the integration of data from data sources of varying data quality. In accordance with embodiments, a new paradigm for Information Management over integrated structured and unstructured data and in real-time is provided. Data quality is handled by associating probability of accuracy with facts extracted from the different data sources. Today, most Natural Language Processing (NLP) engines are rule or grammar based. However, there is a new generation of probabilistic or stochastic NLP engines (pNLP) that can extract facts from unstructured text based on a probability of accuracy of the fact. The pNLP engine can determine one or more possible meanings attached to the words of a document, associate different probabilities with each possible meaning, and return the meaning that has the highest probability of being accurate. Accuracy of the fact refers to whether the fact extracted from the document correctly conveys the meaning intended by the author of the document and that would be understood by a reader of the document. In other words, a fact that has a high degree of probability may still be factually wrong due, for example, to human error on the part of the person entering the data into the document. However, the fact is “accurate” in the sense that it conveys the meaning that would be attached to a human reader of the document.

A traditional pNLP computes the probability of possible meaning of a given word, selects the meaning with the highest probability, and returns the meaning with the highest probability as a fact. In accordance with embodiments, the pNLP engine is modified to export all different meanings of the word along with their corresponding probabilities. Each fact returned by the pNLP engine can be represented in a data format referred to herein as a “tuple.” Each tuple includes a corresponding probability that the fact is accurate. The tuples generated from structured and unstructured data can be combined into an integrated data set, which can then be queried using an information model wherein the client can specify the desired degree of accuracy to their answer. The information model can return the possible different answers with an associated probability of accuracy. In this model, mixing data from low and high quality of data will not impact the answer quality.

Information can be gathered from both structured and unstructured data sources. Information gathered from structured data sources can be associated with a high degree of probability that information is accurate, for example, 100 percent. The data quality of information gathered from unstructured data sources will generally tend to vary. Thus, different probabilities can be associated with different tuples returned from the different unstructured data sources. The tuples and their associated probabilities can be stored to a common data store. A query language that uses probability as an attribute of the result can be applied to the common data store. Additionally, fuzzy reasoning can be applied to the common data store to obtain several possible answers, each of which has an associated probability of accuracy. An information model in accordance with embodiments provides richer data than existing information models as it exposes more information from the same set of data.

In embodiments, the Information Management System is used to provide real-time operational business intelligence. The Information Management System enables specific data to be gathered in a parallel fashion directly from a plurality of operational data sources, in response to a requested business intelligence client operation such as a query, or report request, among others. In this way, data throughout an enterprise network may be accessed in real-time directly from the data sources themselves, rather than relying only on the data that has been previously stored to a data warehouse.

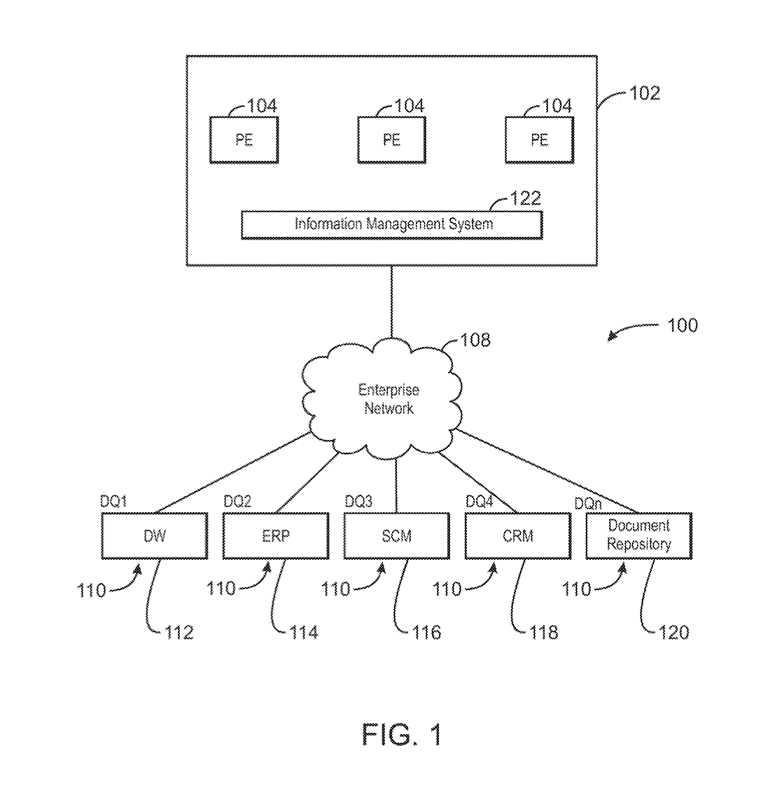

FIG. 1 is a block diagram of a system configured to provide a new Information Model for real-time operational business intelligence, in accordance with embodiments of the invention. The system is generally referred to by the reference number 100. As illustrated in FIG. 1, the system 100 may include a computing device 102, which can be viewed as a cluster of traditional servers running a traditional operating system such as Linux or Windows. The computing device 102 can include one or more processing elements (PEs) 104. For example, the computing device 102 can include a central processing unit (CPU), or a cluster of symmetric multiprocessors (SMPs), among other configurations. The processing elements 104 run specialized application software for collecting relevant data from the different data sources in the enterprise. In an embodiment, the computing device 102 is a general-purpose computing device, for example, a cluster of one or more processing elements 104.

The computing device 102 can be operatively coupled to an enterprise network 108, which may be a local area network (LAN), a wide-area network (WAN), or another network configuration. Through the enterprise network 108, the computing device 102 can access a variety of operational data sources 110, including structured and unstructured data sources, such as data warehouses 112, data marts, a customer relations management (CRM) system 118, an Enterprise Resource Planning (ERP) system 114, document repositories 120, and the like. A data mart is a data storage system, such as a database, configured to support business needs of a department or a division in an enterprise. As used herein, the term “structured data” refers to a data wherein the semantic meaning of the stored data is explicitly defined. For example, a structured data source includes relational databases, XML databases, and the like. The term “unstructured data” is used to refer to a data source wherein the semantic meaning of the data is not explicitly defined. For example, unstructured data can refer to plain text documents, scanned documents, ADOBE® Portable Document Files (PDFs), Microsoft® Word documents. The term “unstructured data” is also used herein to refer to semi-structured data, wherein the semantic meaning of the data is encoded, for example, using metadata tags. Examples of semi-structured documents include eXtensible Markup Language (XML) files, and HyperText Markup Language (HTML) files, among others.

In embodiments, the system 100 includes an Enterprise Resource Planning (ERP) system 114 used to manage internal and external resources, such as financial resources, human resources, materials, equipment, and other tangible and intangible assets. The Enterprise Resource Planning system 114 can be used to provide a roadmap for future business plans of the enterprise, such as planned products, services, acquisitions, and the like and facilitate the flow of information throughout the enterprise and coordinate business operations of the enterprise.

The system 100 can include a supply chain management (SCM) system 116 used to manage the production of products and services provided to end customers. The supply chain management system 116 can be used to track and manage the movement and storage of raw materials, work-in-process inventory, and finished goods from the supplier to the customer.

The system 100 can also include a customer relations management (CRM) system 118 used to track and manage relationships with customers, business clients, and sales prospects of the enterprise. For example, the customer relations management system 118 may be used to keep track of sates activities, marketing activities, customer service interactions, customer complaints, technical support, and the like.

In embodiments, the system 100 includes one or more document repositories 120 used to store important enterprise documents, such as employee work product, technical papers, correspondence, contracts, invoices, legal documents, and the like. Documents stored to the document repository may include power point presentations, emails, PDFs, Microsoft® Word documents, spreadsheets, scanned documents, and the like. Those of ordinary skill in the art will appreciate that the configuration of the system 100 is but one example of a system that may be implemented in an embodiment of the invention. Those of ordinary skill in the art would readily be able to define specific devices, systems, and operational data sources 110, based on design considerations for a particular system.

The computing device 102 also includes an Information Management System 122 configured to execute various data gathering operations against the operational data sources 112. Data may be gathered from each operational data source 112 in a data format native to the particular data source. The process of gathering data from unstructured data sources can be performed by one or more pNLP engines, which extract facts from the unstructured data sources and provide associated probabilities corresponding to each fact. Data can be gathered from structured data sources by a query interface and can be assigned a high probability that the fact is accurate, for example, 100 percent. The data from the unstructured and structured data sources and their corresponding, probabilities can be converted to a common data format and stored to a combined data, structure, which enables probabilistic business intelligence operations, such as probabilistic queries or fuzzy reasoning.

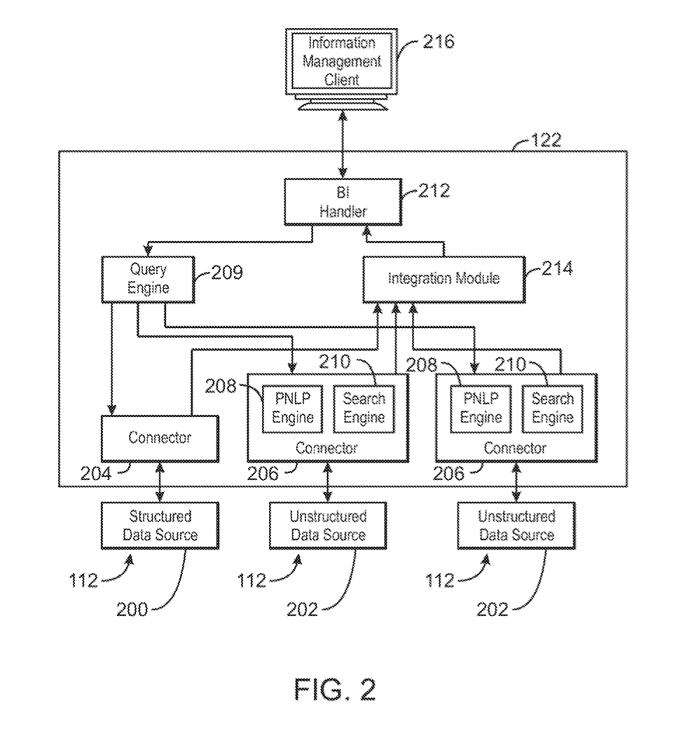

In embodiments, the Information Management System 122 executes the data gathering operations in the course of processing a business intelligence client request, such as executing queries, generating reports, Online Analytical Processing (OLAP), among others. OLAP is a business intelligence technique used to quickly answer multi-dimensional analytical queries. The Information Management System 122 enables specific data to be gathered in a parallel fashion directly from a plurality of operational data sources, in response to a requested operation such as a query, or report request. The requested operation may be performed on the gathered data and the results of the operation may be, for example, stored to a data structure and/or displayed to a user. In embodiments, the Information Management System 122 periodically executes the data gathering operations in the course of updating a data warehouse. Business intelligence operations may then be performed on the data stored to the data warehouse. The Information Manage rent System 122 may be better understood with reference to FIG. 2.

FIG. 2 is a block diagram of an Information Management System configured to provide real-time business intelligence while handling data quality as described earlier, in accordance with embodiments of the invention. Components of the Information Management System 122 are a set of software modules that may leverage specialized hardware such as a solid state drive (SSD) or a field-programmable gate array (FPGA) to optimize execution. In embodiments, components of the Information Management System 122 may be implemented in the computing device 102, as shown in FIG. 1.

The information management system 122 includes a query engine 209 to generate relevant queries for the individual structured and unstructured data sources involved. The query engine 209 can decompose the business intelligence client request into a set of queries to both structured and unstructured data sources. The query engine generates appropriate queries to the corresponding connector 204 (for structured data sources) and connector 206 (for unstructured data sources). The connectors acquire the appropriate data from the corresponding data source 112. Each structured data source connector 204 can be operatively coupled to a corresponding structured data source 200 such as a relational database. XML database, data warehouse, data mart, and the like. The connector 204 can be configured to perform a query of the corresponding structured data source 200 using the data model native to the particular structured data source 200 to which it is coupled. For example, the connector 204 may perform a database query using the structured query language (SQL) or XQuery on XML database, etc.

Each unstructured data source connector 206 may be operatively coupled to an unstructured data source 202, such as a document repository 120 (FIG. 1), Customer Relations Management (CRM) system 118, and the like. One or more documents in the unstructured data source 202 may include metadata tags, which provide semantic meaning to the data contained therein, for example, XML Files. HTML files and the like. Each connector 206 can include a pNLP engine 208 and a search engine 210 such as a semantic search engine. The unstructured data sources 202 may be operatively coupled to the PNLP engine 208 and the search engine 210. One or more documents in the unstructured data source 202 may include semi-structured data such as documents that include metadata tags, which provide semantic meaning to the data contained therein, for example, XML Files. HTML files and the like. The search engine 210 may perform a search of the unstructured data source 202. The search engine 210 can take into account the metadata tags in determining the semantic meaning of the various facts extracted from the unstructured data source 202.

The pNLP engine 208 may be used to extract data from unstructured documents that include plain text, such as Microsoft® Word documents, PDFs, and scanned documents, among others. Some examples, of an unstructured data source 202 can include a document repository 120 (FIG. 1), customer relations management system 118, and the like. The pNLP engine 208 can be generated by analyzing a large corpus of test textual documents within a particular subject matter context. The pNLP engine 208 can use statistical or other machine learning techniques to determine possible meanings for words, based on several occurrences of the same word throughout the corpus and the surrounding context. In some instances, the pNLP engine 208 may generate possibly different meanings for the same word, in which case each possible meaning may be associated with a corresponding probability.

The pNLP engine 208 can be used to extract semantic meanings from the text of the unstructured data source 202. The meanings extracted from the unstructured data source 202 are used, by the pNLP engine 208 to generate a set of tuples, referred to herein as “facts.” Each fact, or tuple, describes a relationship between words that were extracted from the unstructured data source and includes a corresponding probability that the relationship is accurate. In embodiments, facts can be formatted according to a Semantic Web format, i.e., the Resource Description Framework (RDF) specified by the World Wide Web Consortium (W3C), which is also referred to as triples. In embodiments, the RDF data model is extended from triples (subject, predicate, object) to Quads (subject, predicate, object, probability value.) The subject denotes a resource, and the predicate denotes traits or aspects of the resource and expresses a relationship between the subject and the object. The probability identifies the probability that the fact is accurate as determined by the pNLP engine 208. An example of an RDF quad includes a subject “red,” a predicate “color,” an object “car,” and a probability of 80 percent, which conveys that red is the color of a car with a probability of 80 percent. In some cases, the pNLP engine 208 may identify two or more possible meanings for the same word in the unstructured data source 202. Rather than selecting the possible meaning with the highest probability, the pNLP engine 208 is configured to generate facts corresponding to the two or more possible meanings and associate a different probability to each fact. For example, given the same portion of text from the unstructured data source 202, the pNLP engine 208 may generate a first fact indicating that red is the color of a car with a probability of 80 percent and a second fact indicating that red is the color of a dress with a probability of 79 percent.

The particular techniques used to perform the search of the unstructured content may be tailored to the particular type of data that is stored to the corresponding unstructured data source 202. Further, embodiments are not limited to the number or type of data sources 112 shown in FIG. 2, as the Information Management System 122 may be scaled to accommodate any suitable number and type of data sources 112 that may be included in a particular implementation.

In embodiments, the Information Management System 122 can be configured to process business intelligence client requests, and can include a BI handler 212 and an integration module 214. The BI handler 212 can be configured to receive Business Intelligence client requests from a client 216, for example, from a user or analytics software. The business intelligence client request can include queries, requests for reports, OLAP requests, and other business analytics. In embodiments, the business intelligence client operation may also include a context identifier that enables the integration module 214 to identify relevant data sources for the business intelligence client operation. For example, the user may select a financial context, in which case the business intelligence client operation may be applied to data sources 112 that correspond to the finances-related data sources in the enterprise. The BI handler 212 passes the BI request to the query engine 209, which is configured to issue appropriate query or search requests to the relevant connectors.

The integration module 214 collects the results returned from the appropriate data sources 112 through the connectors 204 and 206. The connectors 204 and 206 transform the data returned from each data source to a common data representation incorporating probabilities such as RDF Quads as an extension to the Resource Description Framework (RDF) specified by the World Wide Web Consortium (W3C). The connectors 204 and 206 also reconcile the semantics between different data sources 110. For example, one data source 110 may refer to home address information as “home address” while another data source 110 may refer to the same type of information as “residence address”. The connectors 204 and 206 can be configured to determine that both phrases refer to the same type of information and convert the information to a common semantic representation. For example, the connectors 204 and 206 can be configured to convert instances of “residence address” to “home address” or some other common phrase. The connectors 204 and 206 also reconcile the semantics between the data sources 110 and the domain specific semantics included in the context identifier, which may be provided in the business intelligence client request.

In embodiments, the combined data returned from the relevant connectors are stored into a common data store. If the extended RDF format (i.e., Quads) is used as the common data representation format, the common data store may be referred to as a “quad store,” For example, a quad store can be implemented using ORACLE® 11G, JENA, 3STORE, SESAME, BOCA, or other available software.

The BI handler 212 may perform the requested BI client operation using the common data store generated by the integration module 214. For example, the BI handler 212 may perform an extended version of a SPARQL query on the Quad store containing the quads returned from the integration module 214. Additionall the BI handler 212 may generate a report, create a multidimensional OLAP structure, or perform reasoning with fuzzy ontology on the quads in the quad store using Fuzzy Web Ontology Language (Fuzzy OWL). Other business intelligence client operations that may be performed by the BI handler 212 include analytics such as data mining, statistical analysis, predictive analytics, business process modeling, and other business analytics.

The result provided by the business intelligence client request can include a plurality of answers, wherein each answer can be associated with a probability of certainty that the answer is correct. For example, in response to a probabilistic business intelligence client request such as a probabilistic query, the BI handler 212 can generate a conceptual graph that can be displayed to the user and includes the facts that fit the criteria specified in the query. Each fact can include a certainty indicator corresponding to a degree of certainty that the result provided is accurate. In embodiments, the BI handler 212 is configured to return a result that meets the degree of certainty specified by the certainty specification. For example, the BI handler 212 can use the certainty specification to ignore facts that have a probability that falls below the specified degree of certainty. Furthermore, if the BI handler 212 identifies two or more possible facts whose corresponding probabilities are above the certainty specification, all of these facts may be displayed to the user, including each certainty indicator corresponding to each fact.

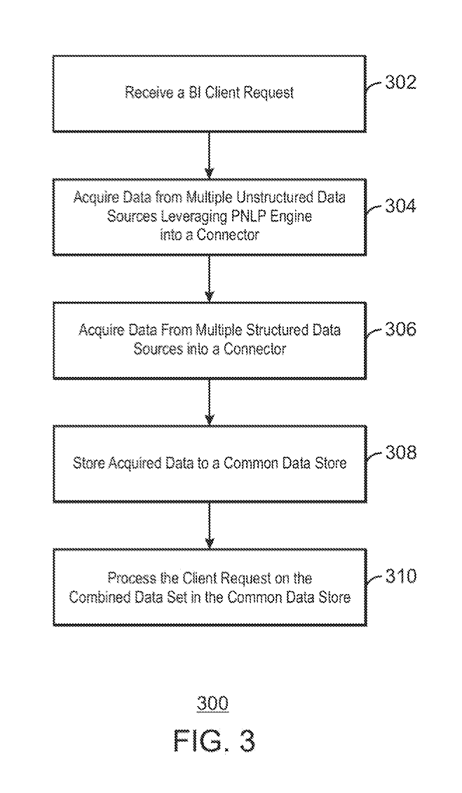

FIG. 3 is a process flow diagram of a method of integrating data from data sources of varying data quality, in accordance with embodiments of the inventions. The method is referred to by the reference number 300 and may be implemented by the Information Management System 122 shown in FIG. 1. In embodiments, the method 300 is triggered by a business intelligence client request received, for example, from the user or analytics software, as discussed in relation to FIG. 2. In such embodiments, the data may be gathered from the various data sources in response to the business intelligence client request. Accordingly, the method may begin at block 302, wherein a business intelligence client request is received. The business intelligence client request may include a query whose result depends on information in one or more structured data sources and one or more unstructured data sources. As discussed in relation to FIG. 2, the business intelligence client request can be received by the BI handler 212 of the Information Management System 122. The BI handler 212 can send the business intelligence client request to the query engine 209, which decomposes the business intelligence client request into any number of suitable data gathering operations to obtain the data corresponding to the business intelligent client operation. For example, the query engine 209 may generate a set of one or more subqueries. The set of subqueries can include SQL queries to be processed by the connectors 204 coupled to the corresponding structured data sources 200. The set of subqueries can also include one or more search requests to be processed by the pNLP engines 208 coupled to the corresponding unstructured data sources 202.

At block 304, data may be acquired from an unstructured data source using a pNLP engine 208, as described in relation to FIG. 2. The acquired data can include a plurality of facts structured as tuples, for example, as RDF quads. Each fact returned by the pNLP engine 208 will include a corresponding probability that the fact is accurate.

At block 306, data can be acquired from a structured data source using a query interface such as the connector 204 (FIG. 2). The data can also include a plurality of facts structured as tuples, for example, as RDF quads. In embodiments, the connector 204 receives data from the structured data source in a data format native to the structured data source. The connector 204 converts the received data into one or more facts and assign a high probability to the fact, for example, approximately 100 percent. In other words, the facts acquired from the structured data sources will be associated with a probability that indicates that the fact is accurate.

At block 308, the data received from the structured and unstructured data sources at blocks 304 and 306 can be stored to a combined data store with a common data format that includes the probabilities. The combined data set can represent the union of each data set returned by the several data gathering operations. In embodiments, the combined data set is an RDF quad store that represents a conceptual graph wherein each fact is expressed as a subject-predicate-object relationship and the corresponding probability. In embodiments, some of the data received from the pNLP engine 208 or the connector 204 may already be represented in the appropriate data model. For example, pNLP engine 208 may encode the structured data extracted from the unstructured data source 202 in the Resource Description Framework data model. Data sets that are not encoded in the common data format may be converted to the common format by the integration module 214.

At block 310, the business intelligence client request can be processed against the combined data set incorporating the probabilities. The BI handler 212 can perform the requested Bi operation using the combined data set generated by the integration module 214. In embodiments, the business intelligence client requests performed against the combined data set can be processed using an extended version of the semantic Web query language (SPARQL), or perform reasoning using fuzzy OWL, as discussed in relation to FIG. 2. The returned results can be cached for future usage.

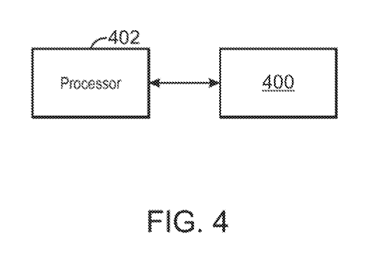

FIG. 4 is a block diagram showing a non-transitory, computer-readable medium that stores code for integrating data from data sources of varying data quality. The non-transitory, computer-readable medium is generally referred to by the reference number 400. The non-transitory, computer-readable medium 400 may correspond to any typical storage device that stores computer-implemented instructions, such as programming code or the like. For example, the non-transitory, computer-readable medium 400 may include one or more of a non-volatile memory, a volatile memory, and/or one or more storage devices.

Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disk drives, compact disc drives, digital versatile disc drives, optical drives, and flash memory devices.

A processor 402, which may be a processing element 104 as shown in FIG. 1, generally retrieves and executes the instructions stored in the non-transitory, computer-readable medium 400 to integrate data from unstructured and structured data sources in a manner that accounts for the varying data quality of the data provided by the different data sources, in accordance with embodiments of the Information Management System 122 describe herein. As discussed above, the processor 402 may be configured to acquire data from an unstructured data source using a probabilistic natural language processor. The data can include a plurality of facts, each fact including a corresponding probability that the fact is accurate. The processor can also be configured to acquire data from a structured data source. The data acquired from the structured data source can include a plurality of facts, each fact including a corresponding high probability, for example, approximately 100 percent. The processor can be configured to store data to a combined data set with a common data format that includes the probabilities. The processor can also be configured to receive a business intelligence client request and acquire data from the two or more data sources in response to the business intelligence client request. In embodiments, the processor is configured to perform the business intelligence client request on the combined data set, for example, using a semantic Web language that takes into account the probabilities.

What is claimed is:

1. An method for information management, comprising:
acquiring a first data set from an unstructured data source using a probabilistic Natural Language Processing (pNLP) engine, the first data set comprising a first tuple that includes a relationship and a corresponding probability that the relationship is accurate;
acquiring a second data set from a structured data source, the second data set comprising a second tuple that includes a second relationship and probability indicating that the second relationship is accurate; and
storing the first and second data sets into a common data store using a common data format that includes the probabilities corresponding to the first data set and second data set.

2. The method of claim 1, comprising receiving a business intelligence client request and decomposing the business intelligence client request into a set of subqueries against the structured data source and the unstructured data source.

3. The method of claim 2, comprising processing the business intelligence client request on the common data store based, at least in part, on the probabilities.

4. The method of claim 2, wherein the business intelligence client request includes a certainty specification associated with the desired answer, and a result of the business intelligence client request meets a degree of certainty specified by the certainty specification.

5. The method of claim 2, wherein a result provided in response to the business intelligence client request includes a plurality of answers, each answer associated with a probability of certainty.

6. A system for providing information management comprising:
a processor that is configured to execute computer-readable instructions; and
a memory device that stores instruction modules that are executable by the processor, the instruction modules comprising:
a probabilistic natural language processing engine configured to extract facts from an unstructured data source, wherein each fact comprises a relationship and a corresponding probability that the relationship is accurate;
a connector configured to extract facts from a structured data source and associate the facts extracted from the structured data source with a degree of probability that indicates that the facts are accurate; and
an integration module configured to store the results returned from the structured data source and the unstructured data source to a common data store that includes the corresponding probabilities associated with each fact.

7. The system of claim 6, comprising a business intelligence handler configured to receive a business intelligence client request and process the business intelligence client request on the common data store based, at least in part, on the probabilities associated with each fact.

8. The system of claim 7, wherein the common data store comprises an extended RDF data model that includes the probabilities associated with each fact.

9. The system of claim 8, wherein the business intelligence handler uses a probabilistic query language or fuzzy reasoning to extract answers from the common data store.

10. The system of claim 6, wherein the integration module is configured to acquire a plurality of facts from a plurality of data sources in response to a business intelligence client request.

11. A non-transitory, computer-readable medium, comprising instructions configured to direct a processor to:
acquire a first data set from an unstructured data source, the first data set comprising a first fact and a corresponding first probability that the first fact is accurate;
acquire a second data set from a structured data source, the second data set comprising a second fact and a corresponding second probability that the second fact is accurate; and
store the first and second data set in a combined data store with a common data format that includes the probabilities corresponding to the first and second data set.

12. The non-transitory, computer-readable medium of claim 11 comprising instructions configured to direct the processor to receive a business intelligence client request and processing the business intelligence client request on the combined data store based, at least in part, on the probabilities.

13. The non-transitory, computer-readable medium of claim 12, wherein the business intelligence client request includes a certainty specification corresponding to a desired degree of certainty that a result provided in response to the probabilistic business intelligence client request is accurate.

14. The non-transitory, computer-readable medium of claim 12, comprising instructions configured to direct the processor to generate a result for the business intelligence client request, the result comprising a certainty indicator corresponding to a degree of certainty that the result is accurate.

15. The non-transitory, computer-readable medium of claim 11, comprising instructions configured to direct the processor to receive a business intelligence client request, wherein acquiring the first data set and acquiring the second data set are performed responsive to the business intelligence client request.
